(19) United States
(12) Patent Application Publication
(10) Pub. No.: US 2009/0218429 A1
(43) Pub. Date: Sep. 3, 2009

(54) HARD ELEMENTS FOR THE AUTOGENOUS WEAR PROTECTION OF ROLLER SURFACES

(76) Inventors: Alexander Hagedorn, Pulheim (DE); Dieter Brendler, Schifferberg (DE)

Correspondence Address: GREER, BURNS & CRAIN, 300 S WACKER DR, 25TH FLOOR, CHICAGO, IL, 60606, US

(21) Appl. No.: 12/281,484

(22) PCT Filed: Mar. 5, 2007
(86) PCT No.: PCT/EP2007/001860

§ 371 Date: Oct. 13, 2008

(30) Foreign Application Priority Data
Mar. 4, 2006 (DE) 10 2006 010 042.5

(51) Int. Cl. B02C 4/30

(52) U.S. Cl. 241/294; 241/228; 241/295

(57) ABSTRACT

The invention relates to hard elements generally produced by powder metallurgy for protecting rolling press rollers from wear, this protection taking the form of grid armouring. In order to provide hard elements which can be produced relatively inexpensively and which, in particular, can again be disassembled in a relatively simple manner, even in the damaged state, from their respective roller body cutouts for the purpose of roller repair, the invention proposes prefabricated hard elements with a prefabricated central cutout which, starting from the radially inner end of the hard elements, extends over at least some of the height of the hard elements.

### BACKGROUND OF THE INVENTION

The invention relates to hard bodies for partial insertion into recesses in the surface of rollers of roller presses for pressure comminution of granular stock material, whereby in operation of the roller press the interstices between the hard bodies, which protrude outwardly, are filled with compressed fine-grained stock material.

In roller presses granular brittle grinding stock is fed into the nip, by which the two pivotable oppositely rotatable rollers are separated from each other, and is subjected to pressure comminution there. Also known is the so called high pressure comminution in a nip of a high pressure roller, also called a roller press, in which individual particles of the grinding stock, which is fed into the nip by friction, are being mutually comminuted in a bed of grinding stock, i.e., in a material fill compressed between both roller surfaces, with application of high pressure. Here the roller surfaces are subject to high wear. At least the following requirements are being demanded from those roller surfaces:

They must have a high wear resistance, being able to be manufactured in a cost-saving way, having good feeding characteristics for the stock to be comminuted and if necessary be able to be repaired by the operator at least partially.

It is known to improve wear resistance of the roller surfaces of roller presses by incorporating into the roller surface a plurality of premanufactured hard bodies, like e.g. powder metallurgical manufactured pin shaped nap bolts, into corresponding tapped blind holes of the roller surface, e.g. DEL-A 41 32 474 FIG. 6 and EP-B-0 578 239.

Thereby the nap bolts, which stand within the radial tapped blind holes, protrude outwardly from the roller surface with such a height that during operation of the roller press the interstices between the nap bolts remain filled with the compressed fine-grained stock material, which forms an autogenous wear protection for the roller surfaces and due to its roughness comprises a good feeding characteristic. This well known roller surface armoring has proved of value in the interparticle comminution practice, especially of ore material. Because in the embodiment of DE-A-41 32 474 FIG. 5 bushing shaped pieces, which do not protrude, but which are flush with the roller surface, are incorporated in the roller body, this kind of roller surface is not covered by the afore-mentioned grid armoring.

In the grid armoring the pin shaped nap bolts sit tightly in their tapped blind holes. Should an exchange of individual nap bolts become necessary, the disassembly of the nap bolts may become difficult, especially when these tapped blind holes are partially broken out.

### SUMMARY OF THE INVENTION

The invention is based on the problem of supplying the afore-mentioned grid armorings of roller press rollers hard bodies, which are able to be manufactured in a cost-saving way and which primarily are easy to disassemble out of their roller body recesses even in a damaged condition for the purpose of repairing the roller.

The hard bodies according to the invention, namely the premanufactured normally powder metallurgical made, e.g., pin shaped respectively cylindrical hard metal nap bolts comprise a central recess, which starting from the radial inner end of the hard body extends at least partially over the hard body height. This central recess is dimensioned such that it does not weaken the hard body, but in any case contributes to cost reduction during manufacture of the premanufactured hard bodies by material saving. The more important advantage of the central recess in the premanufactured hard body is that the central recess is being exploited for disassembly of the hard body being stuck in a corresponding roller body recess, even if it should be partially broken out, by introducing an appropriate tool and/or a pressure medium like pressure oil, compressed air etc. through a central duct opening or a central duct bore to pull or push out and therewith disassembling the hard body.

In this way damaged parts of roller surfaces of roller presses furnished with grid armoring may be repaired with comparatively low effort.

According to a further feature of the invention the premanufactured, especially powder metallurgical made hard metal bodies, may be embodied in such a way that the central recess starting from the radial inner end extending partially over the hard body height has a greater diameter than the adjoining central recess extending to the radial outer end of the hard body, whereby at the junction leading from the radial inner end having a greater diameter to the radial outer end having a smaller diameter a step is embodied, which is suited for an attack of an appropriate tool for the disassembly of a hard body by pulling it out from its roller recess.

### BRIEF DESCRIPTION OF THE DRAWINGS

The invention and its further features and advantages are being explained in more detail in the following sketched embodiment examples.

It is shown in:

FIG. 1: a vertical cut of cylindrical hard body with a central recess introduced into a bore of a roller mantle in a first embodiment;

FIG. 2: a corresponding hard body in a second embodiment, and

FIG. 3: a corresponding hard body in a third embodiment.

### DETAILED DESCRIPTION OF THE DRAWINGS

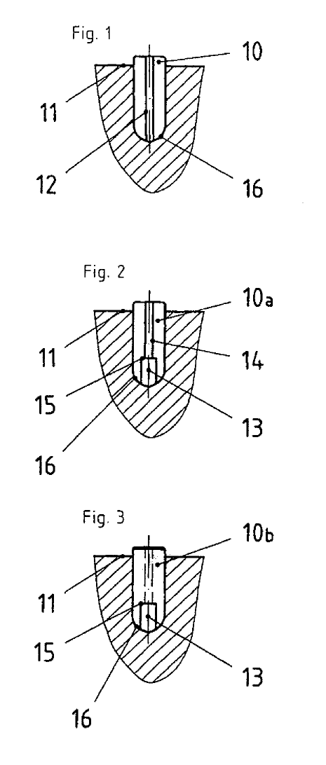

FIG. 1 shows a premanufactured cylindrical, especially from sintered hard metal powder metallurgical made hard body 10, which is introduced into a corresponding bore of the roller mantle 11, for instance pasted in, and having such a height respective length, that it protrudes outwardly from the surface of the roller mantle 11, so that an afore-mentioned grid armoring comes about by an arrangement of a plurality of such hard bodies on the surface of a roller mantle 11 of the rollers of a roller press.

In the embodiment of FIG. 1 the premanufactured hard body 10 comprises a premanufactured central recess 12, which starting from the radial inner end of the hard body extends over the complete height or length of the hard body, that means the central recess is a duct opening. If during operation of the roller press for pressure comminution of granular material there becomes a partial or total damage of the hard body 10, then the duct opening 12 after cleansing from stock material serves for simplified disassembly of the hard body, by introducing into the duct opening 12 an appropriate tool and/or a pressure medium like pressure oil, compressed air etc. for pulling out/pushing out the hard body 10.

In the embodiment of FIG. 2 the central duct opening of the hard body 10a is embodied in such a way that the central recess 13 starting from the radial inner end of the hard body extending partially over the hard body height has a greater diameter than the diameter of the central recess 14 at the radial outer end of the hard body, whereby at the junction leading from the radial inner end having a greater diameter to the radial outer end having a smaller diameter a step 15 is embodied, which is suited for engagement by an appropriate tool for the disassembly of a hard body 10a from its roller boring. Also in this solution before disassembly of the hard bodies 10a from the roller press the adjoining recesses 13 and 14 are cleaned out of processed grinding stock.

According to the embodiment in FIG. 3 in the hard body 10b in its original form, the central recess extending from the radial inner end of the hard body 10b is not embodied in a continuous way, but initially closed facing towards to the top. Here in case of a disassembly of the hard body 10b, above is formed into it from outside to inside, denoted with a dashed line, with an appropriate tool, by which the disassembly also of this type of the hard body 10b can be carried out.

To minimize mechanical stress concentrations with a risk of cleft or crack formation in the roller mantle in the operation of the roller press in all embodiments of the hard bodies their radial inner end like the roller body recesses at their deepest area may comprise approximate the curved shape of a semi-spherical calotte 16.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

1-5. (canceled)

6. A hard body for partial introduction into recesses in a surface of a roller of a roller press for the pressure comminution of granular stock, whereby in operation of the roller press interstices between the hard bodies protruding outwardly from the roller surface are filled with compressed fine-grained stock material for autogenous wear protection, comprising a central recess which starting from a radial inner end of the hard body extends at least partially over a height of the hard body.

7. A hard body according to claim 6, wherein the central recess in the hard body is a duct opening, which extends from the radial inner end to a radial outer end of the hard body.

8. A hard body according to claim 6, wherein the central recess, starting from the radial inner end of the hard body extending partially over the hard body height, comprises a greater diameter than a diameter of the extending central recess at the radial outer end, whereby at the junction between the radial inwardly arranged recess and the radial outwardly central arranged recess having a smaller diameter, a step is formed which is suited for engagement by a tool for disassembly of the hard body from its individual roller recess.

9. A hard body according to claim 6, wherein the hard body is powder metallurgical manufactured and comprises a cylindrical or polygonal shape.

10. A hard body according to claim 6, wherein the radial inner end of the hard body as well as the roller body recesses at their deepest area comprise approximately the curved shape of a semi-spherical calotte.

11. A hard body for introduction into recesses in a surface of a roller of a roller press comprising a central recess extending from a radial inner end of the hard body at least partially along a height of the hard body.

12. A hard body according to claim 11, wherein the central recess in the hard body is a duct opening which extends from the radial inner end to a radial outer end of the hard body.

13. A hard body according to claim 12, wherein the central recess includes a radially outwardly extending portion starting from the radial inner end with a diameter greater than a diameter of a radially inwardly extending portion of the central recess starting from the radial outer end, whereby at a junction between the radial inwardly extending portion and the radial outwardly extending portion, a step is formed.

14. A hard body according to claim 11, wherein the hard body is manufactured of powdered metal.

15. A hard body according to claim 11, wherein the hard body comprises a cylindrical shape.

16. A hard body according to claim 11, wherein the hard body comprises a polygonal shape.

17. A hard body according to claim 11, wherein the radial inner end of the hard body comprises an approximately semi-spherical curved shape.
